(19) United States
(12) Patent Application Publication
(10) Pub. No.: US 2002/0025812 A1
(43) Pub. Date: Feb. 28, 2002

(54) Methods in a communication system

(76) Inventors: Susanne Ahlstrand, Sollentuna (SE); Anders Furuskar, Stockholm (SE); Joakim Sorelius, Uppsala (SE); Claes Tidestav, Balsta (SE); Arnaud Vedrine, Stockholm (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/921,920

(22) Filed: Aug. 6, 2001

Related U.S. Application Data
(60) Provisional application No. 60/223,318, filed on Aug. 7, 2000.

(51) Int. Cl. H04Q 7/20

(52) U.S. Cl. 455/435; 455/67.1; 455/450

(57) ABSTRACT

A method of managing access request identifiers in a communication system comprising a radio network, said access request identifiers being associated with a first packet random access channel used by mobile stations in a first cell to request allocation of uplink transmission resources in the first step. The radio network controls which mobile stations are assigned access request identifiers and/or for how long accesss request identifiers remain assigned to individual mobile stations.

### TECHNICAL FIELD OF THE INVENTION

The invention relates to methods in a communication system. More in particular, the invention relates to management of access request identifiers.

### DESCRIPTION OF RELATED ART

General packet radio service (GPRS) is a standard from the European Telecommunications Standards Institute (ETSI) on packet data in GSM systems. GPRS has also been accepted by the Telecommunications Industry Association (TIA) as the packet-data standard for TDMA/136 systems. By adding GPRS functionality to the public land mobile network (PLMN), operators can give their subscribers resource-efficient access to external Internet protocol-based (IP) networks.

GPRS offers air-interface transfer rates up to 115 kbit/s subject to mobile terminal capabilities and carrier interference. Even higher transfer rates are provided by the use of so called EDGE technology, i.e. Enhanced Data Rates for Global Evolution. EDGE technology can increase end user data rates up to 384 kbit/s, and potentially higher in high quality radio environments. Moreover, GPRS allows several users to share the same air-interface resources and enables operators to charge customers for wireless services based on the amount of transferred data instead of on connection time.

The current specifications of GPRS/EGPRS supports two types of uplink access methods, one-phase access and two-phase access, for providing a mobile station with radio resources in the uplink direction.

In order to provide better support for delay sensitive traffic, an improved faster access procedure for requesting uplink radio resources has recently been proposed for standardisation. The core of this proposal is to standardize a new 8-bit identifier called Access Request Identifier (ARI).

The proposal is for a mobile station to transmit the ARI on the existing uplink packet random access channel (PRACH) using the current GPRS 11-bit access burst message. The ARI, by definition, would then be unique on this PRACH. Based on the ARI and the PRACH on which it was received, the network can uniquely map the received ARI to a communication context defining data received previously from the mobile station. Thus the mobile station does not need to retransmit data defining its access capabilities and the requested uplink resources.

### SUMMARY OF THE INVENTION

The problem dealt with by the present invention is to provide a flexible way of managing access request identifiers.

The problem is solved by methods according to claims 1, 5 or 10

One object of the invention is to provide a flexible way of managing access request identifiers.

An other object of the invention is to enable a radio network to control which mobile stations are assigned access request identifiers.

Still another object of the invention is to enable a radio network to control for how long access request identifiers remains assigned to mobile stations.

Yet another object of the invention is to enable a radio network to control assignment of request identifiers in dependence of the current number of available access request identifiers.

An advantage afforded by the invention is that access request identifiers can be managed in a flexible way.

Another advantage afforded by the invention is that it enables a radio network to control which mobile stations are assigned access request identifiers and/or for how long access request identifiers remain assigned to mobile stations.

Yet another advantage of the invention is that a network operator is afforded the possibility to provide differented services to different subscriber categories.

The invention will now be described in more detail with reference to exemplary embodiments thereof and also with reference to the accompanying drawings.

### BRIEF DESCRIPTION OF DRAWINGS

FIG. 1 is a view illustrating an exemplary mobile telecommunications system in which the present invention can be implemented.

FIG. 2A is a signalling diagram illustrating one-phase access.

FIG. 2B is a signalling diagram illustrating two-phase access.

FIG. 3 is a signalling diagram illustrating ARI-based access.

FIG. 4 is a flow diagram illustrating an exemplary first method according to the invention.

FIG. 5 is a flow diagram illustrating an exemplary second method according to the invention.

### DETAILED DESCRIPTION OF THE EMBODIMENTS

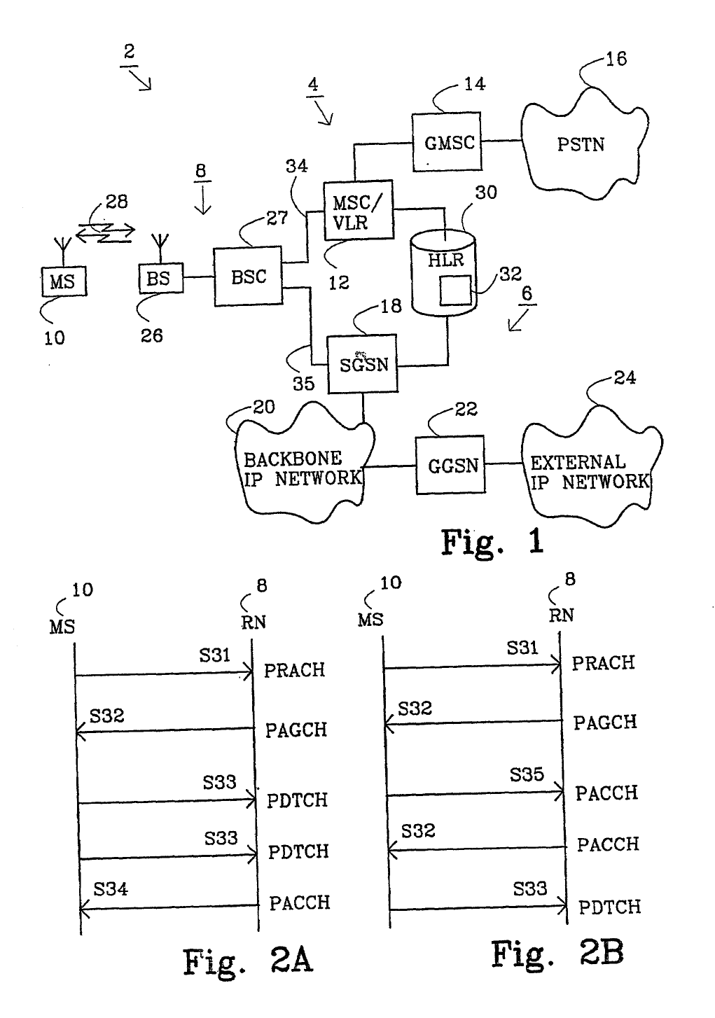

FIG. 1 illustrates an exemplary mobile telecommunications system 2 in which the present invention can be implemented. In particular the system 2 depicted in the FIG. 1 conforms to the GSM specifications and supports GPRS and Enhanced GPRS (EGPRS) technology. The mobile telecommunications system 2 includes a circuit-switched network 4, a packet-switched network 6, and a radio network 8 that is shared by the circuit-switched and packet-switched networks 4 and 6. Generally, the circuit-switched network 4 is primarily used for voice applications, while the packet-switched network 6 is primarily used for data applications. In accordance with third generation mobile telecommunications standards, however, the circuit-switched network 4 can also support data communications, and the packet-switched network 6 can also support voice communications.

The circuit-switched network 4 includes a number of mobile services switching center/visitor location registers (MSC/VLRs) 12. For purposes of simplifying the illustration, however, only one MSC/VLR 12 is shown. Each MSC/VLR 12 serves a particular geographic region and is used for controlling communications in the served region and for routing communications to other MSC/VLRs 12. The VLR portion of the MSC/VLR 12 stores subscriber information relating to mobile stations 10 that are currently located in the served region. The circuit-switched network 4 further includes at least one gateway mobile services switching center (GMSC) 14 that serves to interconnect the circuit-switched network 4 with external networks, such as a public switched telephone network (PSTN) 16.

The packet-switched network 6 includes a number of serving GPRS support nodes (SGSN) 18, which are used for routing and controlling packet data communications, and a backbone IP network 20. A gateway GPRS support node (GGSN) 22 interconnects the packet-switched network 6 with an external IP network 24 or other external data networks.

The radio network 8 includes a plurality of cells. Each cell in the mobile telecommunications system 2 is served by a base station 26 that communicates with mobile stations 10 in the cell via an air interface 28. The radio network 8 comprises a plurality of base stations 26 and a base station controller (BSC) 27, alternatively referred to as a Radio Network Controller (RNC), controlling said plurality of base stations 26. For circuit-switched communications, signals are routed from the MSC/VLR 12, to the base station controller 27 via an interface 34, to the base station 26 for the cell in which the target mobile station 10 is currently located, and over the air interface 28 to the mobile station 10. For packet data transmissions, on the other hand, signals are routed from the SGSN 18, to the base station controller 27 via an interface 35, to the base station 26 for the cell in which the target mobile station 10 is currently located, and over the air interface 28 to the mobile station 10.

Each mobile station 10 is associated with a home location register (HLR) 30. The HLR 30 stores subscriber data for the mobile station 10 that is used in connection with circuit-switched communications and can be accessed by the MSC/VLRs 12 to retrieve subscriber data relating to circuit-switched services. Each mobile station 10 is also associated with a GPRS register 32. The GPRS register 32 stores subscriber data for the mobile station 10 that is used in connection with packet-switched communications and can be accessed by the SGSNs 18 to retrieve subscriber data relating to packet-switched services.

To send data on the downlink, i.e. from the radio network 8 to mobile stations 10, the radio network 8 knows when new packets need to be transmitted to each user. Accordingly, the base station transmits data destined for a particular user as part of a temporary block flow (TBF). The TBF is a connection used by the base station and the user's mobile station to support the unidirectional transfer of packet data on a packet data physical channel. The radio network assigns each TBF a temporary flow identity (TFI) value, which uniquely identifies the TBF, thereby distinguishing the TBF from other TBFs destined for other mobile stations. Based on the TFI value, each individual mobile station that is multiplexed on a specific packet data physical channel is able to determine which data packets are meant for that mobile station. In other words, the base station is able to address data packets to particular mobile stations using the appropriate TFI value. On the uplink portion, i.e. from the radio network 8 to mobile stations 10, of the communication, however, the situation is more cumbersome because the radio network does not know which mobile stations need to send data packets unless and until the mobile stations notify the base station that they have data to be sent. To facilitate data transfers on the uplink, therefore, a mobile station that needs uplink resources informs the base station that it has data packets to send by sending a message on a random access channel (RACH) or a packet RACH (PRACH), which are control channels used only on the uplink to request GPRS resources. The base station can then schedule uplink resources for the mobile station.

The current specifications of GPRS/EGPRS supports two types of uplink access methods, one-phase access and two-phase access, for providing a mobile station with radio resources in the uplink direction.

FIG. 2A illustrates the one-phase access method. The mobile station 10 requiring uplink radio resources initiates an uplink packet transfer, i.e. a TBF, by transmitting a Packet Channel Request message S31 to the radio network 8 on a packet random access channel (PRACH) of the cell in which the mobile station 10 is located. The Packet Channel Request message S31, which is only a very short access burst of 8 or 11 bits, includes a random number for identification purposes.

If the radio network 8 grants the one-phase access, the radio network 8 responds by transmitting a Packet Uplink Assignment message S32 to the mobile station 10 on a packet access grant channel (PAGCH) associated with the packet random access channel. The Packet Uplink Assignment message S32 includes either a Dynamic Allocation Struct or a Fixed Allocation Struct. Parameters in these structures describe the resources the mobile station 10 has been allocated for uplink transfer of RLC data blocks. The Packet Uplink Assignment message S32 also includes the random number the mobile station 10 included in its Packet Channel Request message S31.

When the mobile station 10 receives a Packet Uplink Assignment message S32 in which its random number is included, the mobile station 10 switches to the assigned packet data channel (PDCH). In case of Dynamic or Extended Dynamic Allocation, the mobile station 10 waits for its Uplink State Flag (USF) value to appear in the corresponding downlink transmissions, and then starts transmitting. For Fixed Allocation, the mobile station 10 switches to the assigned packet data channel at the first frame in the allocation bitmap, and starts transmitting.

In one-phase access, the so called Temporary Logical Link Identifier (TLLI) used to provide unique identification of the mobile station 10 within the SGSN 18, is not transmitted during TBF setup. Therefore, the mobile station 10 is required to include its TLLI in all transmissions of RLC data blocks S33, until it receives a Packet Uplink Ack/Nack message S34 that confirms reception of its TLLI. When the mobile station 10 receives the Packet Uplink Ack/Nack that contains the TLLI of the mobile station 10, the mobile station 10 may continue to send RLC data blocks S33 without the TLLI.

FIG. 2B illustrates the so called two-phase access method. The mobile station 10 requiring uplink radio resources initiates an uplink packet transfer, i.e. a TBF, by transmitting a Packet Channel Request message (burst) S31 to the radio network 8 on a PRACH of the cell in which the mobile station 10 is located.

The radio network 8 grants the two-phase access by transmitting a first Packet Uplink Assignment message S32 to the mobile station 10 on the PAGCH associated with the PRACH. The first Packet Uplink Assignment message S32 includes allocation of a single radio block on a PDCH. The mobile station 10 then transmits a Packet Resource Request message S35 in the allocated single radio block. Among other things, this message includes the TLLI to identify the mobile station 10. The radio network 8 responds to the Packet Resource Request message S35 by sending a second Packet Uplink Assignment message S32 in a packet associated control channel (PACCH) on the packet data channel on which the mobile station 10 sent the Packet Resource Request message S35. The second Packet Uplink Assignment message S32 includes either a Dynamic Allocation Struct or a Fixed Allocation Struct, thus providing physical resources for the mobile station 10 to transmit RLC data blocks. Also, the second Packet Uplink Assignment message S32 includes the TLLI of the mobile station 10. When the mobile station 10 receives its TLLI in a Packet Uplink Assignment message S32, it acts on the assignment and switches to the assigned PDCH.

In connection with more recent EGPRS standards (i.e., EGPRS standard release 00), real time applications (e.g., voice-over-IP (VoIP) will be supported. With the introduction of new such services or applications over packet data systems, there will be a large variety of Quality of Service (QoS) demands on the network. Certain users (e.g., those utilizing real time voice applications) will have a very high demand for the availability of transmission resources, whereas users who transmit short messages or electronic mail will be satisfied with a lower availability of transmission resources.

For example, in the well known Universal Mobile Telecommunications System (UMTS), there are four proposed QoS classes: the conversational class, streaming class, interactive class, and background class. The main distinguishing factor between these classes is the sensitivity to delay of the traffic. Conversational class traffic is intended for traffic which is very delay sensitive while background class traffic is the most delay insensitive traffic class. Conversational and streaming classes are intended for real time traffic flows and interactive and background classes are intended for Internet applications (e.g., WWW, E-mail, Telnet, FTP, etc.).

In order to provide better support for delay sensitive traffic, an improved faster resource request procedure has recently been proposed for standardisation. The core of this proposal is to standardize a new 8-bit identifier called Access Request Identifier (ARI).

The proposal is for a mobile station to transmit the ARI on the existing PRACH using the current GPRS 11-bit access burst message. The ARI, by definition, would then be unique on this PRACH. Based on the ARI and the PRACH on which it was received, the network can uniquely map the received ARI to a communication context defining data received previously from the mobile station. Thus the mobile station does not need to retransmit data defining its access capabilities and the requested uplink resources.

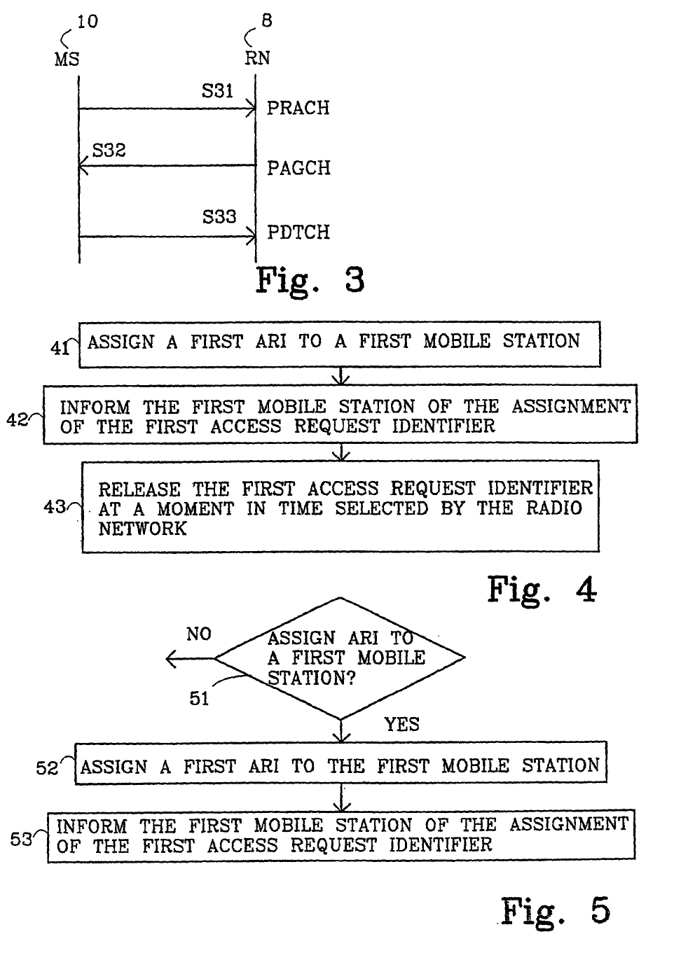

FIG. 3 illustrates how the proposed ARI based resource request procedure is applied.

When the mobile station 10 initially accesses the radio network 8 to transfer data, the radio network 8 has no ARI assigned to the mobile station 10, and a two-phase access as illustrated in FIG. 2B is necessary (alternatively a one-phase access as described above in connection with FIG. 2A may also be used). Thus, as previously described, the mobile station 10 transmits a Packet Channel Request message S31 to the radio network 8, the radio network 8 responds by transmitting a first Packet Uplink Assignment message S32 including a single radio block allocation to the mobile station 10 and the mobile station proceeds by sending a Packet Resource Request message S35 to the radio network 8 in the allocated single radio block. At this point, the radio network 8 assigns an ARI to the mobile station 10 that uniquely (together with the assigned PRACH) identifies the communication context being established.

The radio network 8 informs the mobile station 10 of the assigned ARI by including said ARI in a second Packet Uplink Assignment message S32. Thus, the Packet Uplink Assignment message format is modified to include an optional ARI.

After the mobile station 10 has Completed its first uplink TBF and while the mobile station 10 is assigned an ARI, it might use the assigned ARI to perform fast access procedures as illustrated in FIG. 3 in order to initiate additional uplink TBFs. Thus, when initiating an additional uplink TBF, the mobile station 10 transmits a Packet Channel Request message S31 including the assigned ARI on the PRACH. Upon receiving the ARI included in the Packet Channel Request message S31, the radio network 8 has complete knowledge of the context (quality of service requirements, multi slot capabilities etc) in which the bearer shall operate. The radio network 8 can then immediately assign the necessary resources to the mobile station 10. The radio network 8 transmits a Packet Uplink Assignment message S32 to the mobile station 10 including information on the assigned resources and the ARI received from the mobile station 10 in the Packet Channel Request message S31. The mobile station 10 receives the Packet Uplink Assignment message S32 and recognizes from the included ARI that the message S32 is a response to the previously sent Packet Channel Request message S31. Thus, the mobile station 10 starts transmitting data in the uplink using the assigned resources.

According to the current proposal, the ARI is 8-bits long implying that 256 unique identites can simultaneously be assigned-on one PRACH. The applicant recognizes that the ARI may become a scarce resource, in particular in future packet data systems where each mobile station can be allocated many TBFs simultaneously (and thus many ARIs). Thus, it is important to manage allocation of ARIs in a proper way.

The present invention provides a way of managing access request identifiers in a communication system comprising a radio network, such as the communication system 2 illustrated in FIG. 1.

FIG. 4 illustrates an exemplary first method according to the invention for managing access request identifiers associated with a first packet random access channel used by mobile stations in a first cell of a radio network to request allocation of uplink transmision resources in the first cell.

At step 41, a first access request identifier is assigned to a first mobile station operating in the first cell by associating the first access request identifier with data defining a communication context for the first mobile station. The data defining the communication context may e.g. be data defining a so called Radio Access Bearer.

At step 42, a downlink signal including the assigned first access request identifier is sent from the radio network to the first mobile station informing the first mobile station of the assignment of the first access request identifier.

At step 43, the first access request identifier is released from the first mobile station by disassociating the first access request identifier and the data defining the communication context. The moment in time when the first access request identifier is released is selected by the radio network according to a predetermined rule. Furthermore, the first mobile station continues to operate in a “ready state” within the first cell after release of the first access request identifier, i.e. the release of the first access request identifier is not triggered by the mobile station changing cell or entering a “standby” state. Within the scope of the present invention, the term “ready state” means a state in which the first mobile station informs the communication system when it performs a cell update while the term “standby state” means a state in which the first mobile station does not report to the network each time it changes cell.

In order to ensure that the first mobile station is aware of when the assignment of the first access request identifier is terminated, the radio network may, upon termination of said assignment, transmit a downlink signal to the first mobile station informing the first mobile station that the assignment of the first access request identifier is terminated. Alternatively, the radio network could transmit a downlink signal to the first mobile station including information defining a time period during which the first access request identifier remains assigned to the mobile station. This signal could e.g. be sent simultaneous with or immediately after the downlink signal informing the first mobile station of the assignement of the first access request identifier.

FIG. 5 illustrates an exemplary second method according to the invention for managing access request identifiers associated with a first packet random access channel used by mobile stations in a first cell of a radio network to request allocation of uplink transmision resources in the first cell.

At step 51, it is decided, according to a predetermined rule, whether an access request identifier should be assigned to a first mobile station operating in the first cell.

If it is decided that an access request identifier should be assigned to the first mobile station (an alternative YES at step 51), a first access request identifier is assigned to the first mobile station at step 52 by associating the first access request identifier with data defining a communication context, e.g. data defining a Radio Access Bearer, for the first mobile station. The radio network informs the first mobile station of the assignment of the first radio access identifier at step 53 by transmitting a downlink signal including the assigned first access request identifier from the radio network to the first mobile station.

It is of course possible to combine the first method illustrated in FIG. 4 and the second method illustrated in FIG. 5 such that the radio network decides whether an access request identifier should be assigned to the first mobile station and, provided an access request identifier is assigned to the first mobile station, the radio network selects when the assigned access request identifier should be released.

The predetermined rule for deciding whether an access request identifier should be assigned and the predetermined rule for selecting when to release an assigned access request identifier may both be based on at least one of the following factors:

the current number of unassigned access request identifiers associated with the first packet random access channel;

a quality of service profile associated with the first mobile station;

the characteristics of the first mobile station.

The characteristics of the mobile station may in turn include at least one of:

the amount of data the first mobile station has transmitted in the uplink direction;

the mobility characteristics of the first mobile station;

the equipment characteristics of the first mobile station.

Thus, as a first example, in a situation where the current number of unassigned request identifiers is large, the radio network may assign access request identifiers to all active mobile stations within the first cell and the mobile stations may be allowed to retain the assigned request identifiers for relatively long periods of time, while in a situation where the current number of unassigned request indentifiers is small, the radio network may decide only to assign access request identifiers to mobile stations operated by subscribers having premium subscriptions and/or select only to allow access request identifiers remain assigned to mobile stations for short periods of time.

As a second example, the radio network may decide only to assign access request identifiers to mobile stations associated with quality of service profiles indicating that said mobile stations are operated by premium service subscribers and/or the radio network may select to allow access request identifiers remain assigned to said mobile stations longer than for mobile stations operated by ordinary service subscribers.

As a third example, the radio network may assess the amount of data a mobile station has transmitted recently and decide to assign an access request identifier and/or select to allow the access request identifier remain assigned to the mobile station for a long period of time if the mobile station has transmitted a lot of data, and hence is likely to continue transmitting more data, while the radio network may decide not to assign any access request identifier if the mobile station has only transmitted a small amount of data.

As a fourth example, the radio network may assess the mobility characteristics of a mobile station, i.e. whether the mobile station exhibits a stationary or roaming behaviour, when deciding whether to assign an access request identifier and/or selecting for how long an access request identifier may remain assigned to the mobile station. Thus, the radio network may decide to assign an access request identifier for a long period of time to a mobile station exhibiting a stationary behaviour while deciding not to assign any access request identifier or selecting to allow an access request identifier remain assigned only for a short period of time if a mobile station exhibits a roaming behaviour.

As a fifth example, the radio network may assess the equipment characteristics of a mobile station when deciding whether to assign an access request identifier and/or select for how long an access request identifier may remain assigned to the mobile station. Thus, the radio network may e.g. assign access request identifiers for long periods of time to mobile stations in the form of network cards attached to computers which are expected to be stationary and transmit and receive data in an interactive manner over a long period of time.

In a typical communication system implementing methods of the invention, deciding whether access request identifier should be assigned to mobile station and selecting for how long access request identifier should remain assigned to mobile stations are handled by a base station controller/radio network controller node in the radio network. However, these tasks may also be handled by base stations in the radio network.

Also, in a typical communication system implementing methods according to the invention, access request identifiers assigned to mobile stations are not only released in accordance with the invention but also whenever the mobile stations changes cell in ready state or enters a standby state.

1. A method of managing access request identifiers in a communication system comprising a radio network, said access request identifiers being associated with a first packet random access channel used by mobile stations in a first cell of the radio network to request allocation of uplink transmission resources in the first cell, the method comprising the steps of:
deciding, according to a predetermined rule, whether an access request identifier should be assigned to a first mobile station operating in the first cell and, if it is decided that an access request identifier should be assigned, performing the further steps of:
assigning a first access request identifier to the first mobile station by associating the first access request identifier with data defining a communication context for the first mobile station;
informing the first mobile station of the assignement of the first access request identifier by transmitting a downlink signal including the assigned first access request identifier from the radio network to the first mobile station.

2. A method according to claim 1, wherein the predetermined rule for deciding is based on at least one of the following factors:
the current number of unassigned access request identifiers associated with the first packet random access channel;
a quality of service profile associated with the first mobile station;
the characteristics of the first mobile station.

3. A method according to claim 2, wherein the characteristics of the first mobile station includes at least one of:
the amount of data the first mobile station has transmitted in the uplink direction;
the mobility characteristics of the first mobile station;
the equipment characteristics of the first mobile station.

4. A method according to any one of claims 1-3, wherein the method comprises the additional step of releasing the first access request identifier by disassociating the first access request identifier and the data defining the communication context, wherein the radio network selects, according to a predetermined rule, when to release the first access request identifier and wherein the first mobile station continues to operate in a ready state within the first cell after release of the first access request identifier.

5. A method of managing access request identifiers in a communication system comprising a radio network, said access request identifiers being associated with a first packet random access channel used by mobile stations in a first cell of the radio network to request allocation of uplink transmission resources in the first cell, the method comprising the steps of:
assigning a first access request identifier to a first mobile station operating in the first cell by associating the first access request identifier with data defining a communication context for the first mobile station;
informing the first mobile station of the assignement of the first access request identifier by transmitting a downlink signal including the assigned first access request identifier from the radio network to the first mobile station;
releasing the first access request identifier by disassociating the first access request identifier and the data defining the communication context,
wherein the radio network selects, according to a predetermined rule, when to release the first access request identifier and wherein the first mobile station continues to operate in a ready state within the first cell after release of the first access request identifier.

6. A method according to any one of claims 4-5, wherein the radio network transmits a downlink signal to the first mobile station informing the mobile station that the assignment of the first access request identifier to the mobile station is terminated.

7. A method according to any one of claims 4-5, wherein the radio network transmits a signal to the first mobile station including information defining a time period during which the first access request identifier remains assigned to the mobile station.

8. A method according to any one of claims 4-7, wherein the predetermined rule for selecting is based on at least one of the following factors:
the current number of unassigned access request identifiers associated with the first packet random access channel;
a quality of service profile associated with the first mobile station;
the characteristics of the first mobile station.

9. A method according to claim 8, wherein the characteristics of the first mobile station includes at least one of:
the amount of data the first mobile station has transmitted in the uplink direction;
the mobility characteristics of the first mobile station;
the equipment characteristics of the first mobile station.

10. A method of managing access request identifiers in a communication system comprising a radio network, said access request identifiers being associated with a first packet random access channel used by mobile stations in a first cell of the radio network to request allocation of uplink transmission resources in the first cell, wherein assignment of access request identifiers is controlled by the radio network in dependence of the current number of unassigned access request identifiers.
